(19) United States
(12) Patent Application Publication
(10) Pub. No.: US 2018/0247274 A1
(43) Pub. Date: Aug. 30, 2018

(54) Method and System for Organizing Meetings Using Mobile Devices

(71) Applicant: Alexey LIPENDIN, Los Gatos, CA (US)

(72) Inventor: Alexey LIPENDIN, Los Gatos, CA (US)

(73) Assignees: PropertyMinders.com, San Jose, CA (US); MediaBoost.com, San Jose, CA (US)

(21) Appl. No.: 15/906,309

(22) Filed: Feb. 27, 2018

Related U.S. Application Data
(60) Provisional application No. 62/463,922, filed on Feb. 27, 2017.

(51) Int. Cl. G06Q 10/10; G06F 3/0482; G01S 19/51

(52) U.S. Cl. CPC G06Q 10/1095; G06F 3/03545; G01S 19/51; G06F 3/0482

(57) ABSTRACT

The disclosure pertains to a computer-implemented method and a system for organizing a meeting using mobile devices of a user and one or more participants, a server, and a global positioning system (GPS), and to computer-readable storage media containing instructions that organize a meeting using the mobile devices, the server, and the GPS.

### CROSS REFERENCE TO RELATED APPLICATION(S)

This application claims the benefit of U.S. Provisional Patent Application No. 62/463,922, filed on Feb. 27, 2017, incorporated herein by reference as if fully set forth herein.

### FIELD OF THE INVENTION

The present invention generally relates to the field of organizing meetings. More specifically, embodiments of the present invention pertain to a computer-implemented method and a system of organizing a meeting using mobile devices, a server, and a GPS, and computer-readable storage mediums containing instructions that organize a meeting using mobile devices, a server, and a GPS.

### SUMMARY OF THE INVENTION

In one aspect, the invention relates to a computer-implemented method for organizing a meeting, comprising identifying a meeting location and selecting a starting time on a graphical user interface (GUI) of a mobile device of a user, selecting or entering one or more participants for the meeting using the GUI on the mobile device of the user, transmitting one or more invitations to at least one mobile device of each of the participant(s) (e.g., “invited participants”) using the GUI on the mobile device of the user and a server to which the mobile device of the user is operably linked, receiving at least one acceptance from at least one of the participant(s) (e.g., “accepting participants”) using the mobile device of the user and the server, determining a distance between the meeting location and each of (i) the mobile device(s) of the accepting participant(s) and (ii) the mobile device of the user, calculating an estimated time of arrival (ETA) from each of the accepting participant(s) and the user to the meeting location, and displaying on the mobile devices of each of the user and the accepting participant(s) the ETA(s) of the other(s) of the user and the accepting participant(s). A global positioning system (GPS) and the server are used to determine the distance between the meeting location and the mobile devices, and the GPS, the server and the mobile devices are used to calculate the ETAs.

In some embodiments, the method further comprises displaying an electronic map showing the meeting location on the GUI of the mobile devices of each of the user and the accepting participant(s). The method may also further comprise prompting the user and the accepting participant(s) to transmit to the mobile device of the other(s) of the user and the accepting participant(s) the location of the mobile device of the prompted user or the prompted participant, using the server and the GUIs on the mobile devices of each of the user and the accepting participant(s).

In other or further embodiments, the method further comprises displaying an electronic map showing the meeting location on the GUI of the mobile devices of each of the user and the accepting and/or prompted participant(s). The electronic map may show the location(s) of the prompted user and the prompted participant(s) choosing to display their location.

In some embodiments, the method further comprises transmitting a reminder to the mobile devices of the user and the accepting participant(s) a predetermined time before the meeting. The method may also further comprise, in response to a selection, stimulus or input from the user, displaying a list of meetings on the GUI of the mobile device of the user. Each meeting in the list of meetings may include a title, a meeting location, a starting time, a name of each of the invited participant(s), and optionally an ending time.

In other or further embodiments, the method further comprises, in response to a selection, stimulus or input from the user, displaying a list of the invited participant(s) on the GUI of the mobile device of the user. Each participant in the list of the invited participant(s) may include (1) a participant name and (2) a participant email address or a participant phone number.

In some embodiments, identifying the meeting location may comprise selecting the meeting location from a list of predetermined meeting locations, and selecting the starting time may comprise selecting the starting time from a list of predetermined starting times. In other or further embodiments, the method further comprises calculating a second ETA from each of the accepting participant(s) and the user to the other(s) of the accepting participant(s) and the user using the GPS, the server and the mobile devices, and displaying on the mobile devices of each of the user and the accepting participant(s) the second ETA(s) of the other(s) of the user and the accepting participant(s).

Another aspect of the invention relates to a system for organizing a meeting, the system comprising a mobile device of a user having a graphical user interface (GUI) configured to enable the user to designate a location and a starting time of the meeting, one or more mobile devices of one or more participants, a global positioning system (GPS) operably linked to the mobile devices of the user and the device(s) of the participant(s), and a server operably linked to the GPS and the mobile devices of the user and the participant(s). Each mobile device has a GUI configured to enable the corresponding participant to accept an invitation to the meeting. The GPS is configured to track locations of the mobile devices of the user and the participant(s). The server is configured to (i) receive (1) the location and the starting time of the meeting from the mobile device of the user, (2) an acceptance of the invitation from the mobile device(s) of the participant(s), and (3) the locations of the mobile devices of the user and the participant(s) from whom the acceptance is received (e.g., accepting participant[s]) from the GPS, (ii) calculate an estimated time of arrival (ETA) of the user and the accepting participant(s) to the location of the meeting, and (iii) transmit the ETA of each of the user and the accepting participant(s) to the mobile device(s) of the other(s) of the user and the accepting participant(s). The meeting location may be designated from a list of predetermined locations, and the starting time may be designated from a list of predetermined starting times.

In some embodiments, the user's mobile device and the corresponding GUI are configured to display an electronic map that shows a location of the meeting. The user's mobile device may be configured to display an interface enabling the user to transmit to the mobile devices of the participant(s) the first ETA of the user, and optionally, the location of the user's mobile device. The mobile device(s) of each of the accepting participant(s) may be configured to display an interface enabling each of the accepting participant(s) to transmit to the mobile devices of the user and the other accepting participant(s) the first ETA of the respective and/or corresponding accepting participant, and optionally, the location of the respective and/or corresponding accepting participant.

In various embodiments, the mobile devices of the user and the accepting participant(s) are configured to display an electronic map that shows the meeting location and the location(s) of the user and the other accepting participants who transmit their location(s) to the others' mobile devices. In response to a selection, stimulus or input from the user, the GUI of the user's mobile device may display (1) a list of meetings and/or (2) a list of the participant(s). Each meeting in the list of meetings may include a title, a meeting location, a starting time, a name of each of the participants, and optionally an ending time. Each participant in the list of participants may include (1) a participant name and (2) a participant email address or a participant phone number.

In further embodiments, the server may be configured to calculate a second ETA from the user and the accepting participant(s) to the other(s), and transmit the second ETA of each of the user and the accepting participant(s) to the mobile devices of the other(s).

A further aspect of the invention relates to a tangible computer-readable storage medium storing a set of instructions, which when executed by a processor on a mobile device of a user, cause the processor and/or the mobile device to at least (1) enable the user to identify a location and a starting time of a meeting, (2) enable the user to select one or more participants to the meeting, (3) enable the user to transmit one or more invitations to the participant(s), (4) enable the user to receive an acceptance from each of the participant(s), and (5) display on a graphical user interface (GUI) of the mobile device of the user an estimated time of arrival (ETA) to the location from each of (i) the user and (ii) the participant(s) from whom the acceptance is received (“accepting participant[s]”).

In some embodiments, the set of instructions may further include at least one instruction to display an electronic map on the GUI of the user's mobile device showing the meeting location and/or a location of each of the accepting participant(s). The locations of only those accepting participant(s) giving an authorization to display their location may be displayed.

In other or further embodiments, the set of instructions may include at least one instruction to enable the user to transmit the location of the user's mobile device to each of the accepting participants. The electronic map may therefore further show the location of the user's mobile device. The set of instructions may include at least one instruction to display on the GUI of the mobile device of the user a reminder a predetermined time before the meeting.

In various embodiments, the set of instructions may further include at least one instruction to display a list of meetings on the GUI of the user's mobile device. As for the above method, each meeting in the list may include a title, a meeting location, a starting time, a name of each of the (invited) participants, and optionally an ending time. The set of instructions may further include at least one instruction to display a list of the participants on the GUI of the user's mobile device. As for the above method, each participant in the list may include (1) a participant name and (2) a participant email address or a participant phone number.

In still other or further embodiments, the set of instructions may include instructions to (i) display on the GUI of the user's mobile device a list of predetermined meeting locations, (ii) enable the user to select the meeting location from the list of predetermined meeting locations, (iii) display on the GUI of the user's mobile device a list of predetermined starting times, (iv) enable the user to select the starting time from the list of predetermined starting times, and/or (v) display on the GUI of the user's mobile device a second ETA of (1) the user to each of the invited or accepting participants and/or (2) the accepting participants to the other accepting participant(s).

Yet another aspect of the present invention relates to a tangible computer-readable storage medium storing a set of instructions, which when executed by a processor on a server, cause the processor and/or the server to (1) receive and store a location and a starting time for a meeting from a mobile device of a user, (2) transmit one or more invitations to at least one mobile device of one or more participants received from the mobile device of the user, (3) receive at least one acceptance from at least one mobile device of the participant(s), (4) using a global positioning system (GPS) and the server, determine a distance between the meeting location and each of the mobile devices of (i) the user and (ii) the participant(s) from whom the acceptance is received (“accepting participant[s]”), (5) using the server, calculate an estimated time of arrival (ETA) to the meeting location from each of (i) the user and (ii) the accepting participant(s), and (6) using the server, transmit to the mobile devices of each of (i) the user and (ii) the accepting participant(s) the ETAs of the other(s) of the user and the accepting participant(s). The invitation(s) may include the meeting location and the starting time of the meeting, the title, a name of each of the user and any other (invited) participants, and the ending time. Each participant in the list of (invited) participants may be associated with (1) a participant name and (2) a participant email address or a participant phone number stored on the server. The meeting may include a title, the meeting location, the starting time, a name of each of the (invited) participants, and optionally an ending time.

In various embodiments, the set of instructions further includes at least one instruction to (i) prompt the accepting participant(s) to transmit to the mobile device of the other(s) of the user and the accepting participant(s) the location of the mobile device of the prompted participant, (ii) display on the GUI of the user's mobile device a location of each of the accepting participants from whom an authorization to display their location is received, (iii) transmit the location of the mobile device of the user to each of the accepting participant(s) from whom the acceptance is received (e.g., when authorized by the user), (iv) transmit at a predetermined time before the meeting a reminder to the user and the one or more participants from whom the acceptance is received, and/or (v) calculate a second ETA of each of the user and the accepting participant(s) to the other(s) and to transmit to the mobile devices of each of the user and the accepting participants the second ETAs of the other(s).

The present method, system and storage media enables users such as service providers, service customers, managers and employees of companies, family members and friends to organize meetings, invite various participants and determine estimated arrival times of attendees quickly and conveniently. The present method, system and storage media also enables participants (such as service providers, service customers, managers and employees of companies, family members and friends) to easily indicate their attendance at such a meeting, propose specific times for the meeting, and view estimated arrival times of other attendees. These and other capabilities and advantages of the present invention will become readily apparent to those skilled in the art upon reading and understanding the following detailed description of various embodiments and the accompanying drawings that form a part of this application.

### BRIEF DESCRIPTION OF THE DRAWINGS

FIG. 1 is a flowchart showing an exemplary method of organizing a meeting in accordance with one or more embodiments of the present invention.

FIG. 2 is an exemplary diagram showing a system for organizing a meeting in accordance with one or more embodiments of the present invention.

FIG. 3 is an exemplary display on the GUI of a mobile device enabling a user to invite participants to a meeting in accordance with one or more embodiments of the present invention.

FIG. 4 is an exemplary display on the GUI of a mobile device enabling a user to view and edit user preferences, start a new meeting, view current meetings, edit settings, and sign out of an application in accordance with one or more embodiments of the present invention.

FIG. 5 is an exemplary display on the GUI of a mobile device enabling a user to start a new meeting and view current meetings in accordance with one or more embodiments of the present invention.

FIG. 6 is an exemplary display on the GUI of a mobile device enabling a user to enter a meeting location, designate the meeting location on a map, and receive suggested meeting locations in accordance with one or more embodiments of the present invention.

FIG. 7 is an exemplary display on the GUI of a mobile device enabling a user to select predetermined starting times and set a starting time of a meeting in accordance with one or more embodiments of the present invention.

FIG. 8 is an exemplary display on the GUI of a mobile device enabling a user to confirm the meeting title, location and starting time of a meeting, and the participants to be invited to the meeting in accordance with one or more embodiments of the present invention.

FIG. 9 is an exemplary display on the GUI of a mobile device enabling a user to edit the details of the currently active meeting, postpone a meeting, and invite participants to a meeting in accordance with one or more embodiments of the present invention.

FIG. 10 is an exemplary display on the GUI of a mobile device enabling a user to communicate with participants in accordance with one or more embodiments of the present invention.

FIG. 11 is an exemplary display on the GUI of a mobile device enabling a user to view and edit the title, location, starting time, and ending time of a meeting, the timing of an alert or reminder, and details of the user in accordance with one or more embodiments of the present invention.

FIG. 12A is an exemplary display on the GUI of a mobile device enabling a user to view the meeting location on a map and the estimated times of arrival of each participant, and choose to transmit (i) their current location and ETA or (ii) only their ETA in accordance with one or more embodiments of the present invention.

FIG. 12B is an exemplary display on the GUI of a mobile device showing the meeting location and the locations of the meeting attendees on the map, and enabling the user or participant to transmit only their ETA in accordance with one or more embodiments of the present invention.

FIG. 13 is an exemplary display on the GUI of the user's mobile device enabling the user to view and edit the photo, name, category, email address, and phone number of a participant, and select a notifications setting for the participant in accordance with one or more embodiments of the present invention.

FIG. 14 is an exemplary display on the GUI of a mobile device enabling a user or participant to edit notification settings for meetings in accordance with one or more embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

The technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise.

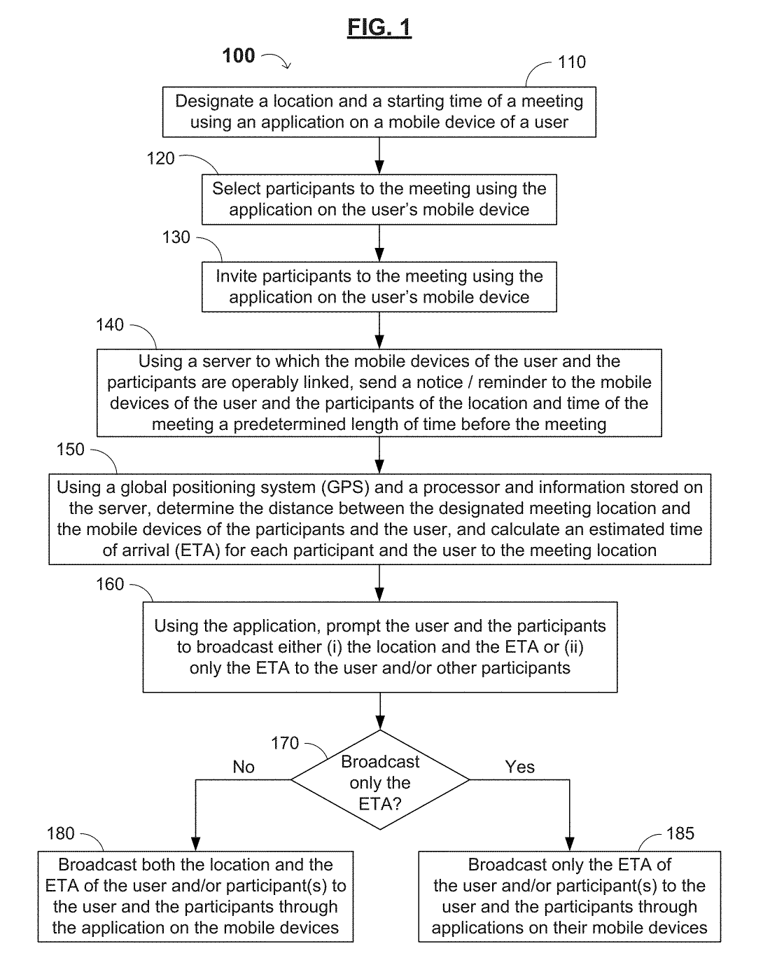

FIG. 1 is a flowchart 100 showing an exemplary method for organizing a meeting using a server, a GPS, and mobile devices of a user and one or more participants.

At 110, a location and a starting time of a meeting are designated using an application on the mobile device of the user. The application may display a map that allows the user to designate a predesignated or predetermined location. Alternatively, the address of the location may be entered into a field or selected from a list of previously designated locations. The application may display a list of predetermined starting times (e.g., “One Hour from Now”) that allows the user to select and designate the starting time. Alternatively, the user may enter the starting time manually by entering into a field. In a further alternative, the list of predetermined starting times may include hour-minute combinations (e.g., 5:30 P.M. or 1:00 A.M.) where the hour and minute may be listed together or separately, and may be selected from a drop-down list or a scrollable list.

At 120, participants are selected for invitation to the meeting using the application on the mobile device of the user. The application may display names, avatars, email addresses and/or phone numbers of the participants to be selected. The selections are generally made by tapping on a participant name or avatar, although other selection mechanisms (e.g., dragging the name or avatar to a predefined field) are possible.

At 130, one or more participants are invited to the meeting using the application on the mobile device of the user, and optionally, the server. The mobile device of the user (and optionally the server) send an invitation to each of the participants using a network that can access the mobile device(s) of the participants. Each participant accepts or rejects the invitations on their mobile devices, at each participant's option. The server receives the acceptance(s) and rejection(s), if any, and may store each acceptance and rejection with a flag or pointer associating it with the contact information of the participant from whom the acceptance or rejection is received.

At 140, using a server to which the mobile devices of the user and the participants are operably linked, the mobile devices of the user and the participants who accepted the invitation are sent a notice or reminder of the location and time of the meeting from the server at a predetermined time (e.g., one day, one hour, 30 minutes, etc.) before the meeting. The notice or reminder may comprise a message (e.g., a pop-up message) appearing on screens of the mobile devices, and may include the meeting time, meeting location, and names of attendees, for example. Multiple notices or reminders may be sent.

At 150, after the notice or reminder is sent to the participants who accepted the invitation, the distance between the designated meeting location and each of the mobile devices of the participant(s) who accepted the invitation and the user are determined, and an estimated time of arrival (ETA) for each participant who accepted the invitation and the user to the meeting location is calculated by one or more known methods using a global positioning system (GPS), a processor and the contact information stored on the server.

For example, the GPS may comprise multiple orbiting satellites that transmit radio signals. The mobile devices may receive a radio signal from each of at least three different orbiting satellites. The time it takes for the radio signals to reach a given one of the mobile device reveals the distances of the orbiting satellites to the mobile device. Since the locations of the orbiting satellites are known, the location of each of the mobile devices may be determined using the process of triangulation. The GPS may also be an assisted GPS, where a radio signal from a nearby cell phone tower or wireless network may be used for triangulation, in addition to the radio signals from the satellites.

At 160, using the application, the user and the participants who accepted the invitation receive a prompt that queries the user and such participants whether to broadcast either (i) their location and their ETA or (ii) only their ETA to the user and/or other such participants. The user and such participants respond to the prompt. At 170, the server receives the answer or reply to the prompt from the user and the participant(s) who accepted the invitation. If the user or participant chose to broadcast their location and their ETA, then the method proceeds to 180. If the user or participant who accepted the invitation chose to broadcast only their ETA, then the method proceeds to 185. The ETAs (and optionally the location[s]) from the server are received and shown on a map displayed on the mobile devices of the user and the participants who accepted the invitation. The ETAs may be displayed on the map next to the names or avatars of the user and the participants who accepted the invitation.

At 180, the locations and the ETAs of the user and the participant(s) who accepted the invitation and who chose to broadcast their location and ETA are broadcast from the server and/or the mobile devices of the user and such participant(s) to the other(s) of the user and the participant(s) who accepted the invitation and who chose to broadcast their location and ETA. At 185, only the ETA of each user and participant who chose to broadcast only their ETA is broadcast from the server and/or the mobile device of such user or participant, to the other(s) of the user and the participant(s) who accepted the invitation. However, the user or participant who chose to broadcast only their ETA can see only the ETA(s) of the other(s).

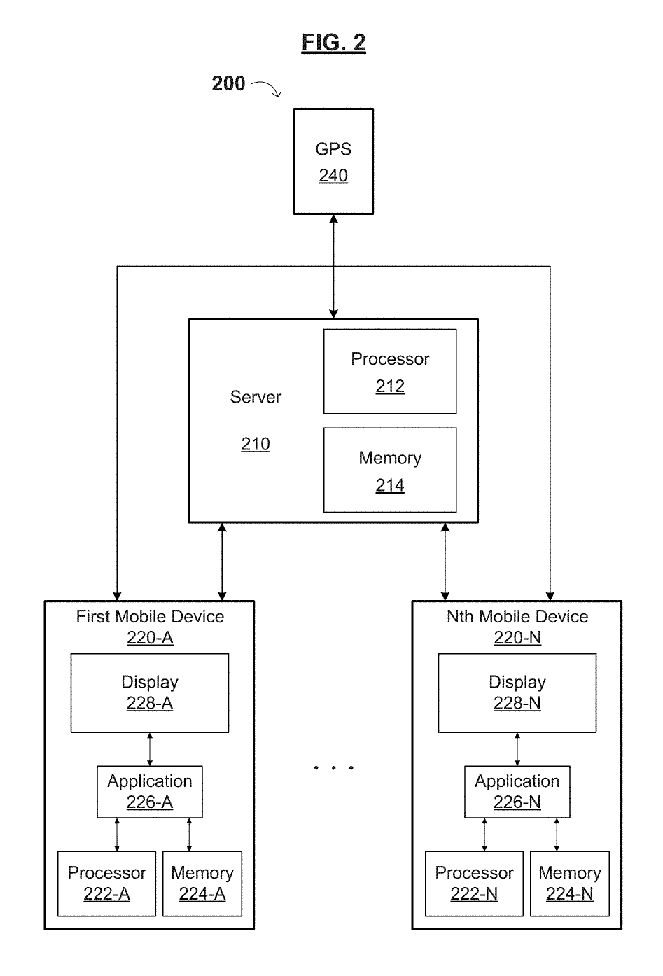

FIG. 2 shows an exemplary system 200 for organizing a meeting, comprising a global positioning system (GPS) 240, a server 210, and first through Nth mobile devices 220-A (e.g., of a user) through 220-N (e.g., of N−1 participants). For example, if each participant has one mobile device, the system 200 includes the mobile devices of N−1 participants.

The server 210, the mobile devices 220-A through 220-N and the GPS may all communicate with each other using a network (e.g., the Internet). The network may comprise routers, data lines, hubs, and intermediary servers. Data may be transmitted through the network using digital and/or analog signals. The network may comprise electrical and/or optical transmission lines for transmitting electrical or optical signals, respectively. The network may comprise devices for converting electrical signals to optical signals, and vice versa.

The server 210 may contain hardware components such as a processor 212 configured to fetch information and instructions and execute the instructions. The processor 212 may calculate an estimated time of arrival of the user or one or more participants to a location using information from the GPS. A memory 214 may be configured to store instructions and information or data regarding meetings. For example, the memory 214 may store information such as starting times and locations of meetings, users and their contact information, lists of one or more participants for each user and the participants' contact information, reminders, and messages (e.g., between the user or a participant and the other[s] of the user and the participant[s]). The memory 214 may be primary or secondary, volatile memory such as random-access memory (RAM) or non-volatile memory such as a hard disk drive (HDD) or solid-state drive (SSD). The server 210 may comprise various server architectures including an everything-on-one architecture (e.g., the processor 212 and memory 214 are on the same server), a separate database architecture (e.g., the processor 212 is part of a first server, and the memory 214 is part of a second separate server in a local area network with the first server), a load balancer or reverse proxy architecture (e.g., the processor 212 comprises several processers across several servers), or a HTTP accelerator or caching reverse proxy architecture (e.g., caching requests from the mobile devices 220-A through 220-N in the memory 214, so that consequent requests can be served quickly).

Each of the first through Nth mobile devices 220-A through 220-N may contain hardware components such as a processor 222-A . . . 222-N configured to fetch and execute instructions, a memory 224-A . . . 224-N configured to store instructions and information or data regarding meetings, and a display 228-A . . . 228-N. The meeting information or data may include a starting time and/or location of the meeting, the user, the participant(s), meeting acceptees (i.e., participants who accepted an invitation), reminder times, and messages (e.g., between the user or a participant and the other[s] of the user and the participant[s]).

Each of the first through Nth mobile devices 220-A through 220-N may include an application 226-A . . . 226-N. In general, the application 226-A . . . 226-N is the same on each of the mobile devices 220-A through 220-N, but the application 226-A . . . 226-N can be different versions of the same application or different applications that can interface and/or interact with each other. The application 226-A . . . 226-N may comprise a graphical user interface (GUI) displaying screens, tabs, bars, buttons, icons, and text fields. The user may interact with the graphical user interface using a touch screen, a mouse, a keyboard, or other electronic input device.

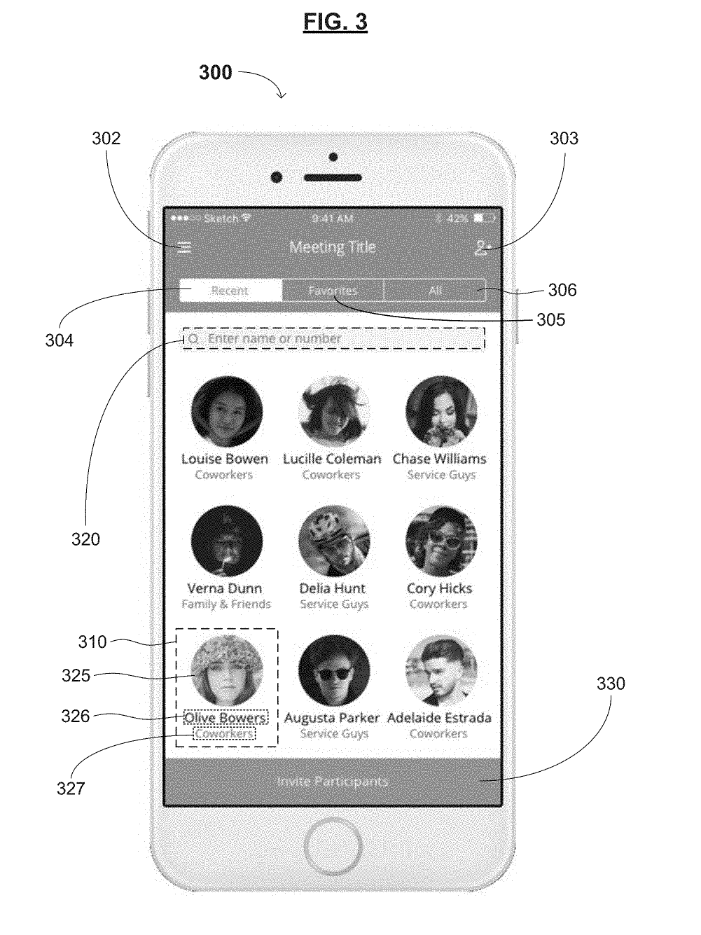

FIGS. 3-14 show screens of the GUI on a user or participant mobile device implementing the application 226-A . . . 226-N of FIG. 2. For example, FIG. 3 shows a participant selection screen 300 comprising a menu icon or button 302, a participant finder icon or button 303, a recent participants tab 304, a favorite participants tab 305, an “all participants” tab 306, a participant search field and function 320, an invitation button 330, and participant selection buttons 310.

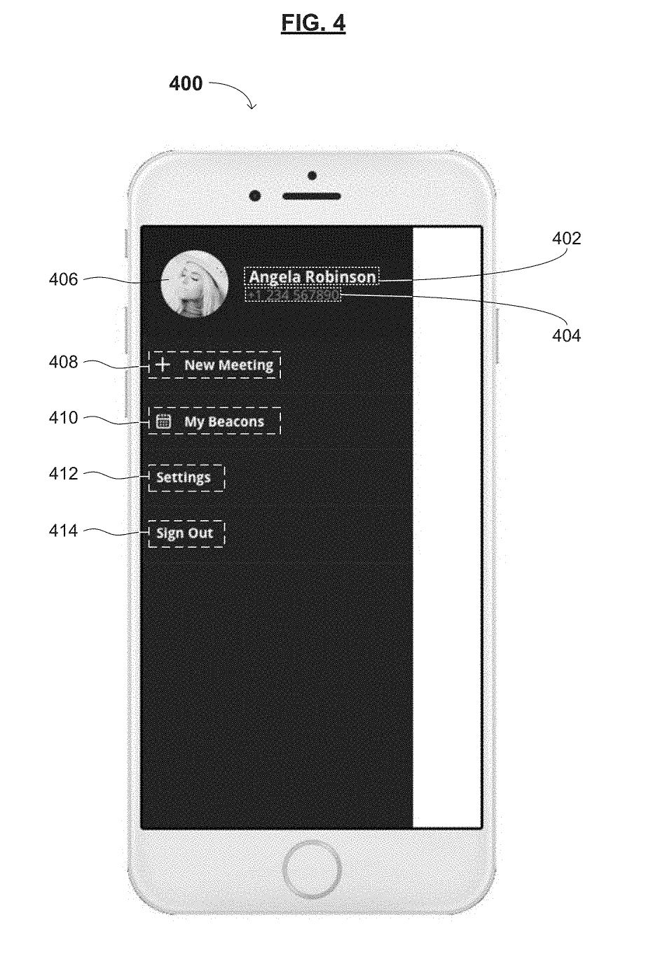

The menu icon or button 302 navigates to a menu screen (e.g., menu screen 400 in FIG. 4). The participant finder icon or button 303 allows the user to access a screen to find participants to be added to one or more lists of participants and/or invited to the meeting (e.g., using an Internet search function or other similar service.)

The recent participants tab 304 allows the user to select and invite participants that have been recently invited to a meeting. Tapping the recent participants tab 304 reveals a pull-down or scrollable menu of participants that have been recently invited to a meeting. The favorite participants tab 305 allows the user to select and invite participants from a list of participants designated as a “favorite.” Tapping the favorite participants tab 305 reveals a pull-down or scrollable menu of participants designated as a favorite. The “all participants” tab 306 allows the user to select and invite participants from a complete list of all the participants stored on the user's mobile device. Tapping the “all participants” tab 306 reveals a pull-down or scrollable menu of all the participants stored on the user's mobile device.

The participant selection buttons 310 include a participant image or avatar 325, a participant name 326, and a participant type or category 327 (e.g., “Friends,” “Family,” “Service Providers,” “Coworkers,” etc.). Tapping the participant selection buttons 310 highlights the participant avatar 325 and/or the participant name 326, and selects a participant for invitation to the meeting.

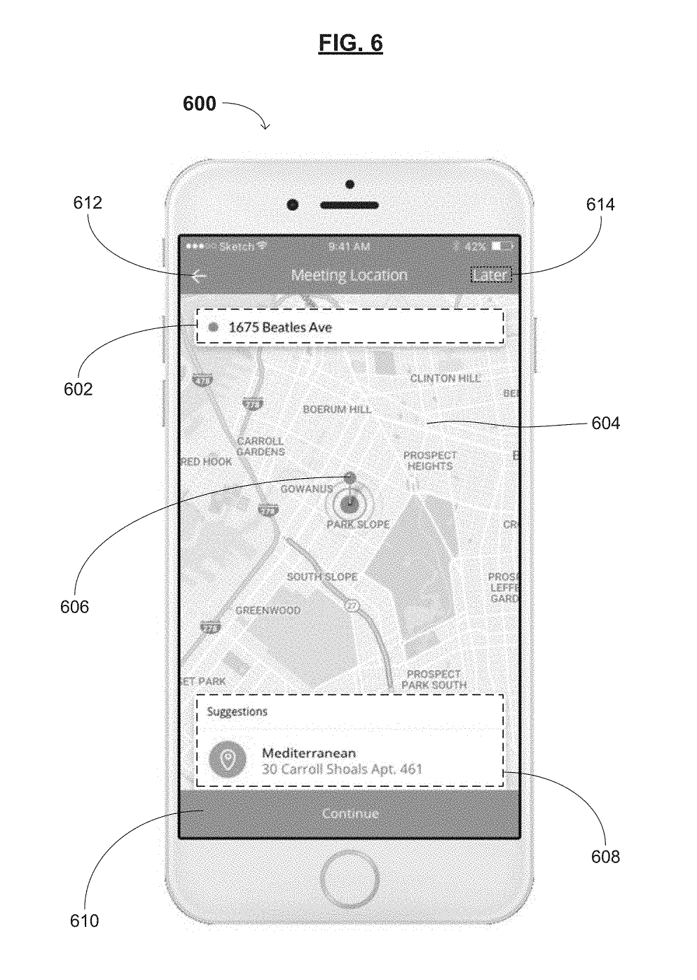

The participant search field 320 allows the user to search (on the mobile device of the user) for participants to be selected and invited to the meeting by typing one or more search criteria such as name, category, phone number or email address. Only participants with matching search criteria are displayed. The invitation button 330 sends an invitation to each of the selected participants. In one embodiment, the invitation button 330 also navigates the user to a location selection screen (e.g., location selection screen 600 in FIG. 6).

FIG. 4 shows an exemplary menu screen 400 that may appear when the menu icon or button 302 is tapped or pushed. The menu screen 400 includes a new meeting button 408, a list of meetings button 410, a settings button 412, and a sign out button 414.

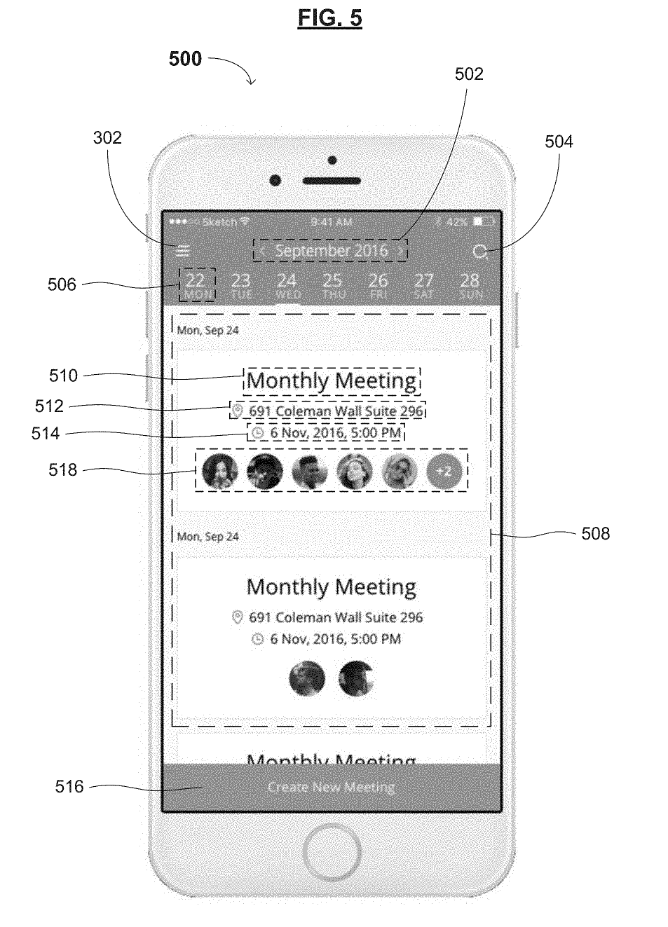

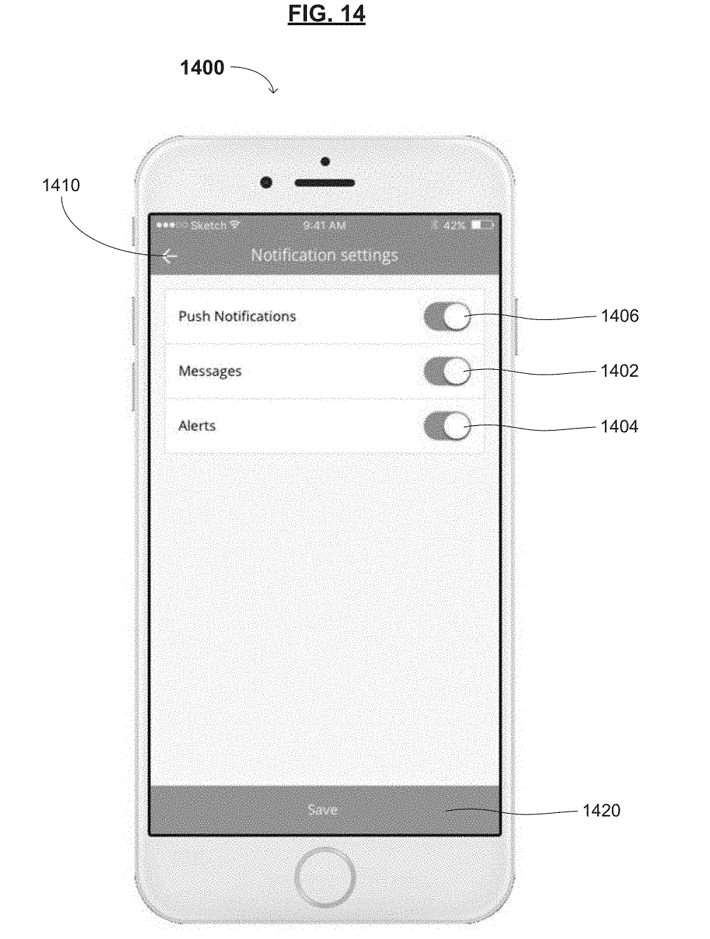

The new meeting button 408 may navigate to the participant selection screen 300 (FIG. 3) or to a screen for defining a new meeting (e.g., by entering a meeting name, starting time, location, frequency, etc.) such as location selection screen 600 in FIG. 6. The list of meetings button 410 may navigate to a list of meetings screen (e.g., list of meetings screen 500 in FIG. 5) that allows the user to view one or more lists of meetings (e.g., currently scheduled meetings, previous meetings, recurring meetings, etc.) and select a meeting for editing. The settings button 412 navigates to a settings screen (e.g., settings screen 1400 in FIG. 14) that allows the user to view and edit settings regarding push notifications, messages and/or alerts or reminders. The sign out button 414 allows the user to sign out and exit the application. The menu screen 400 may also display a user name 402, a user phone number 404, and a user image or avatar 406 that may be edited.

FIG. 5 shows an exemplary list of meetings screen 500 comprising a month selector 502, a meeting finder button 504, a day selector 506, a list of meetings 508, a new meeting button 516, and the menu icon 302. Meetings can be displayed in chronological order, alphabetically, by meeting location, etc., as desired. The user can scroll down the list of meetings screen 500 to find a desired meeting.

The month selector 502 allows the user to view meetings scheduled for a specific month. Clicking on the arrows in the month selector 502 changes the currently viewed month to the next month or the previous month. The meeting finder button 504 allows the user to search for a scheduled meeting. Tapping on the meeting finder button 504 displays a screen or pop-up window with a text field and on-screen keyboard for entering criteria such as a meeting name or location. Only meetings with matching criteria are displayed. The day selector 506 allows the user to view all the meetings scheduled for a specific day of a month. The list of meetings 508 displays a list of all meetings scheduled for the selected time period. Each meeting in the list of meetings 508 includes a meeting title 510, a meeting location 512, a meeting time 514, and a list of participants 518. The list of participants 518 may show names, avatars, etc., of invited participants and/or participants who accepted the invitation (may be designated differently). The new meeting button 516 navigates to the participant selection screen 300 (FIG. 3).

FIG. 6 shows an exemplary location selection screen 600 comprising a location search field 602, a map 604, a location marker 606, a location suggestion bar 608, a continue button 610, a return button or icon 612, and a postpone icon 614. Typically, the location selection screen 600 appears when setting a new meeting (e.g., after selecting participants to be invited), but it can also appear in response to selecting a location of an existing meeting to be edited.

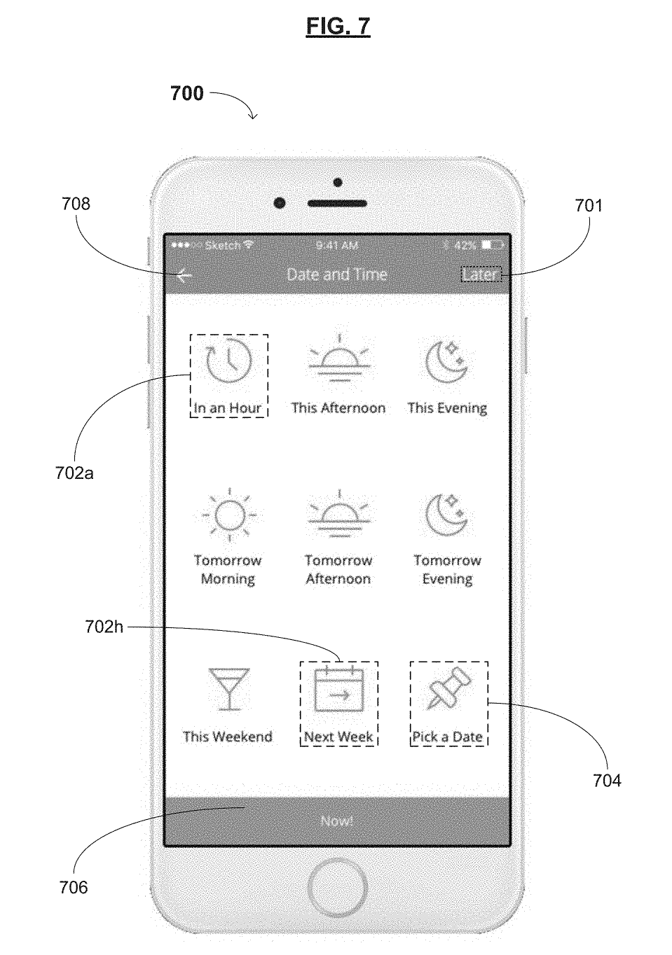

The location search field 602 allows the user to search for a location using criteria entered with an on-screen keyboard (not shown). The map 604 allows the user to place one or more location markers 606 for facilely designating the location. Alternatively, the one or more location markers 606 may appear in response to selecting the meeting location using the search field 602 or the location suggestion bar 608. The location suggestion bar 608 allows the user to select and/or designate a location from a list of suggested locations (e.g., generated from previously selected, designated, and/or entered locations). A location can be selected in the location suggestion bar 608 by tapping on the icon or address. The continue button 610 navigates to the next screen (e.g., starting time selection screen 700 in FIG. 7). The return button 612 navigates to the previous screen (e.g., participant selection screen 300 in FIG. 3). The postpone icon 614 allows the user to designate a location for the meeting at a later time. In one embodiment, tapping or pushing the postpone icon 614 navigates the user to a next screen (e.g., starting time selection screen 700 in FIG. 7).

FIG. 7 shows the starting time selection screen 700 comprising predetermined starting time icons 702a-h (icons 702b-g are not labelled, but are shown on the screen 700), a specific starting time icon 704, a continue button 706, a return button 708, and a postpone icon 710.

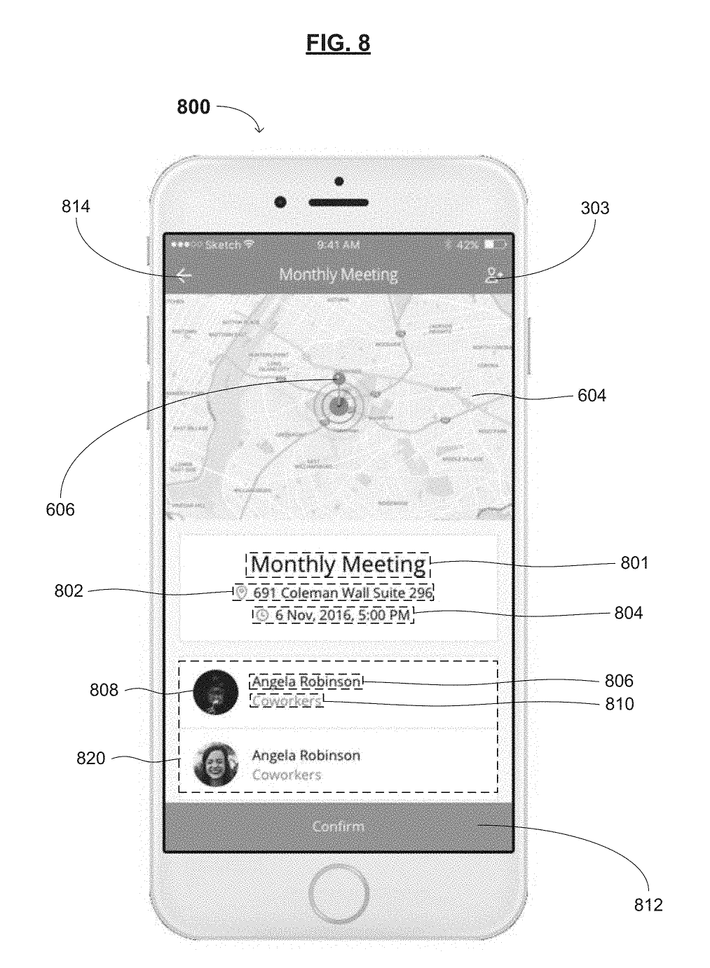

The predetermined starting time icons 702a-h allow the user to select one of a plurality of different starting times for the meeting. For example, the predetermined starting time icon 702a designates one hour from the user's current time as the starting time for the meeting. The predetermined starting time icon 702h allows the user to propose an unspecified time in the next week for the meeting, or to designate a starting time one week from the user's current time. Other starting time icons allow the user to propose general time periods such as this afternoon, this evening, tomorrow, this weekend, etc. for the meeting time. The user (or, in some embodiments, a participant) can then propose or set a specific starting time for the meeting at a later time. The specific starting time icon 704 allows the user to designate the starting time for the meeting by entering a specific date and time (e.g., Oct. 7, 2018, 3:30 PM). The user may designate the starting time for the meeting from a drop-down menu containing a list of years, months, days, hours and minutes. The continue button 706 navigates the user to a next screen (e.g., confirmation screen 850 in FIG. 8). The return button 708 navigates the user to the previous screen (e.g., location selection screen 600 in FIG. 6). The postpone icon 710 allows the user designate the starting time for the meeting at a later time.

FIG. 8 shows an exemplary confirmation screen 800 for reviewing and confirming the meeting information comprising a current meeting name 801, a current meeting location 802, a current meeting starting time 804, a list of current participants 820 including participant names 806, participant avatars 808 and participant categories 810, a confirmation button or bar 812, a return button or icon 814, the participant finder icon 303, and optionally the map 604 with the location marker 606.

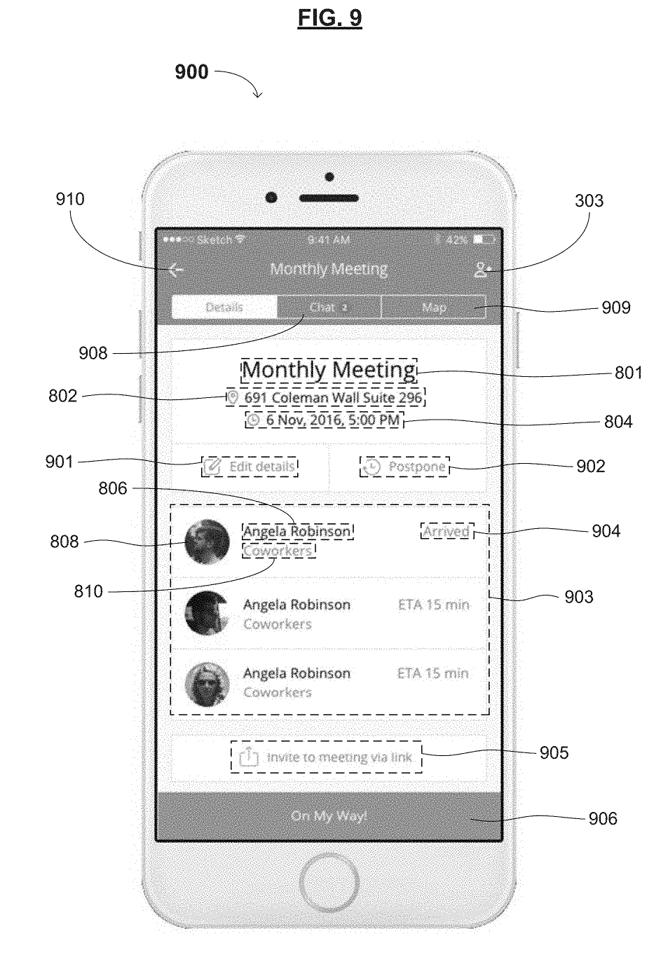

Tapping the confirmation button 812 confirms the details of the meeting and navigates to a next screen (e.g., current meeting screen 900 in FIG. 9). Tapping the return button 814 navigates to a previous screen (e.g., the starting time selection screen 700 in FIG. 7).

FIG. 9 shows an exemplary current meeting screen 900 for coordinating a scheduled meeting, comprising a current meeting editing button 901, a postpone button 902, a list of invitees 903, an invitation button or bar 905, a toggle or travel indicator button or bar 906, a chat tab 908, a map tab 909, a return button 910, and the participant finder icon 303. Current meeting information including the current meeting name 800, the current meeting location 802 and the current meeting starting time 804 may be given in a prominent location (e.g., at the top) of the current meeting screen 900. The list of invitees 903 may include current participant names 806, current participant avatars 808, and optionally, the current participant category 810. The list of invitees 903 also includes an estimated time of arrival (ETA) 904 for each invitee near or next to the invitee name 806 and/or avatar 808.

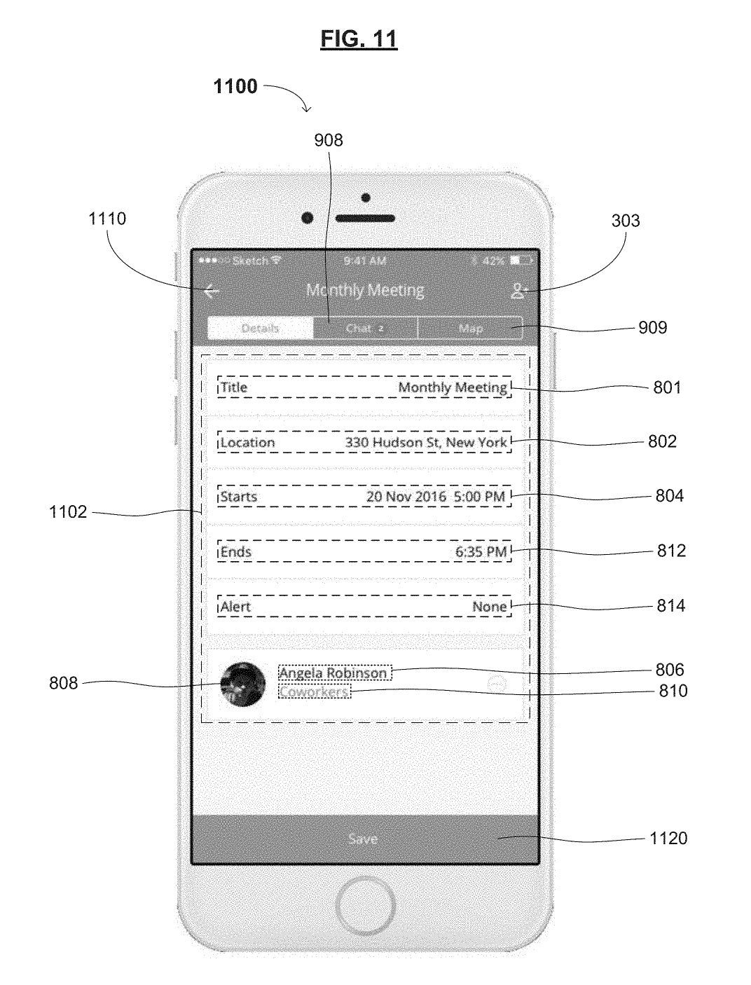

The current meeting editing button 901 navigates to a meeting editing screen (e.g., meeting editing screen 1100 in FIG. 11). The postpone button 902 allows the user to postpone the currently scheduled meeting. In one embodiment, the postpone button 902 also navigates to a screen enabling the user to reschedule the meeting (e.g., starting time selection screen 700 in FIG. 7).

The ETA 904 is an estimated length or duration of time that a current participant may take to arrive at the meeting location. The ETA 904 may be calculated by the server and/or the GPS. The invitation button 905 automatically sends an invitation to the participants by sending a text message, email, or other electronic message to each of the listed and/or selected participants. Alternatively, the invitation button 905 navigates to a screen allowing the user to invite participants to the meeting in a manner that does not use the application (e.g., a text messaging application, an email application, etc.).

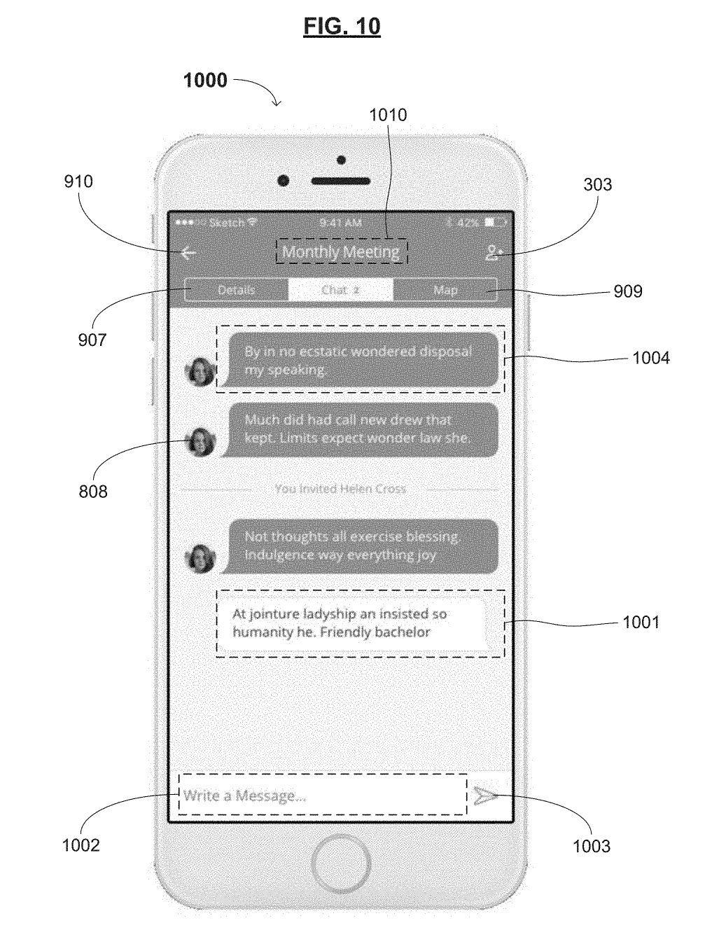

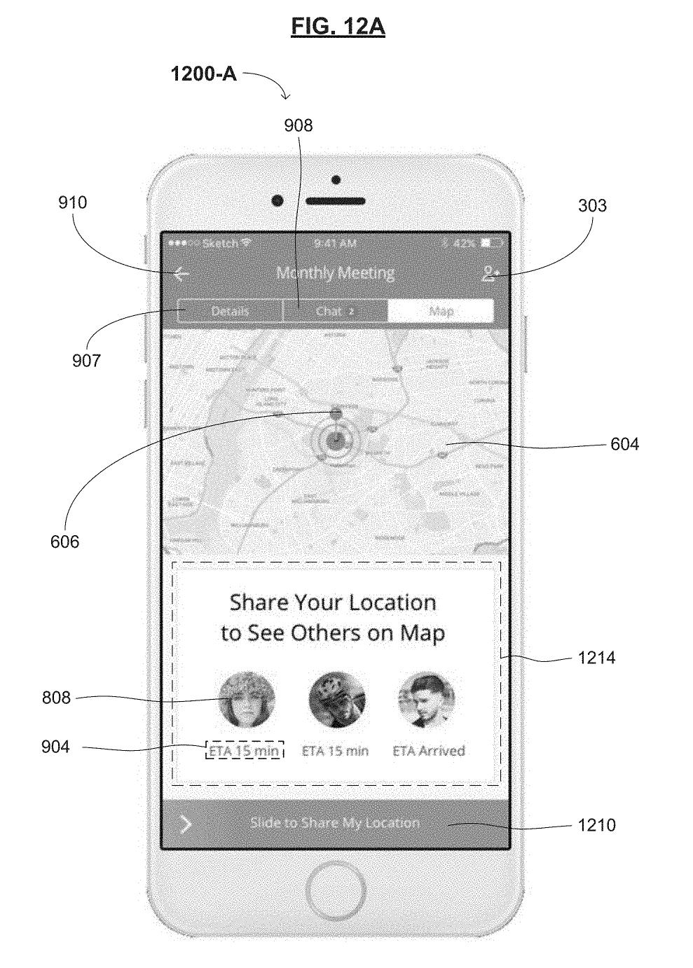

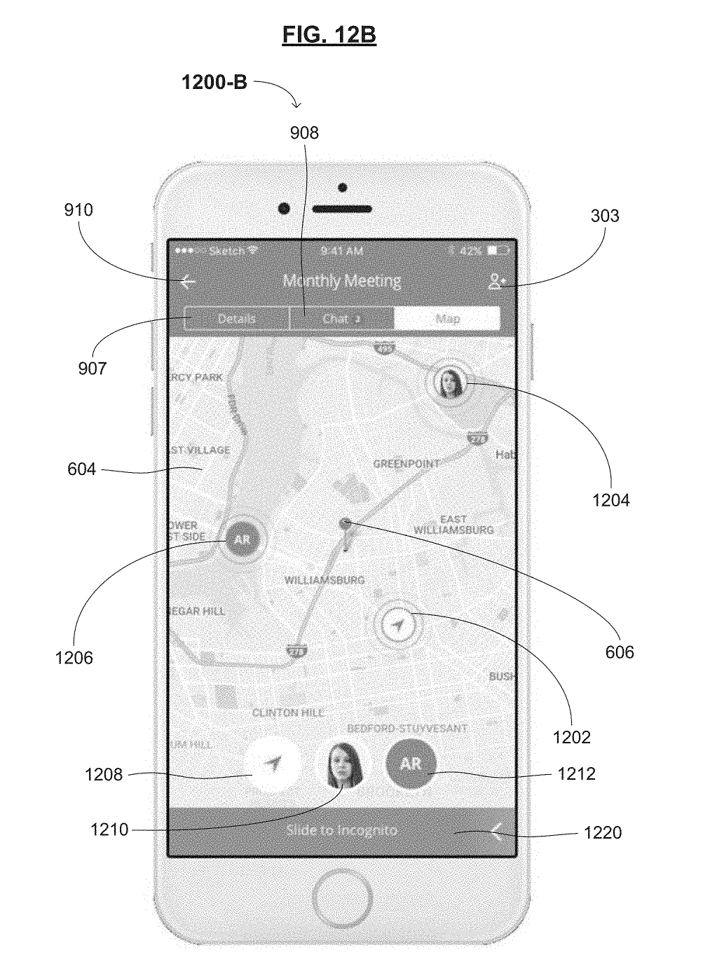

The toggle or travel indicator button or bar 906 allows the user to inform the participants that the user is currently on the way or en route to the meeting. The chat tab 908 navigates to a chat screen (e.g., chat screen 1000 in FIG. 10). The map tab 909 navigates to a map screen (e.g., map screen 1200-A in FIG. 12A or map screen 1200-B in FIG. 12B). The return button or icon 910 navigates to a previous screen (e.g., the confirmation screen 800 in FIG. 8).

FIG. 10 shows an exemplary chat screen 1000 that allows the user and current participant(s) to communicate with each other through typed messages. The chat screen 1000 comprises a meeting information tab 907, a received message 1004, a sent message 1001, a message field or function 1002, a send button or icon 1003, the participant finder icon 303, the current participant avatar 808, the map tab 909, and the return button 910. The meeting information tab 907 navigates to a screen (e.g., the current meeting screen 900 in FIG. 9, the meeting editing screen 1100 in FIG. 11, etc.) that displays information about the meeting named in a screen title 1010. The message field or function 1002 enables the user to enter a message using an on-screen keyboard. The send button 1003 sends the message typed into message field or function 1002 to the other participants attending the meeting. The return button or icon 910 navigates to a previous screen (e.g., the confirmation screen 800 in FIG. 8). The map tab 909 is the same as in FIG. 9.

FIG. 11 shows an exemplary meeting editing screen 1100 that allows the user to edit details of the currently scheduled meeting comprising a current meeting information selection field 1102, an exemplary ending time 812, an alert or reminder function 814, a return button or icon 1110, a save button or bar 1120, the participant finder icon 303, the chat tab 908, and the map tab 909. The meeting information selection field 1102 includes buttons or bars 1100 for editing the meeting name 801, the meeting location 802, the meeting starting time 804, the participant name 806, the participant avatar 808, and the participant category 810. More than one participant can be listed or shown. Tapping or pushing on any of the fields, bars or buttons 801, 802, 804, 812 and 814 opens the field for editing and may cause a keyboard to appear on the screen or GUI.

The alert or reminder function or bar 814 can also or alternatively toggle on or off the sending of a reminder a predetermined time before the meeting starting time 804. The return button 1110 navigates to a previous screen (e.g., the current meeting screen 900 in FIG. 9). The save button 1120 applies any changes made on the meeting editing screen 1100 to the meeting and saves them in the memory of the user's mobile device and the server.

FIG. 12A shows an exemplary map screen 1200-A that allows the user to view the meeting location and ETAs of the participants to the meeting location. The map screen 1200-A comprises a toggle button 1201, the participant finder icon or screen 303, the return button 910, the meeting information tab 907, the chat tab 908, the map 604 with the location marker 606 thereon, and a participant field 1214. The participant field 1214 displays the participant avatars 808 and their corresponding estimated time of arrival (ETA) 904. Activating the toggle button 1200 broadcasts the location of the user to the participant(s) or attendee(s) and navigates to another screen (e.g., the alternative map screen 1200-B in FIG. 12B, the meeting list screen 500 in FIG. 5, etc.). The return button or icon 910 navigates to a previous screen (e.g., the confirmation screen 800 in FIG. 8).

FIG. 12B shows an alternative map screen 1200-B comprising the participant finder icon or screen 303, the return button 910, the current meeting tab 307, the chat tab 308, the map 604, the map tab 309, and the toggle button 1200. The map screen 1200-B appears when the user or participant shares their location information with others. The map 604 displays the meeting location marker 606, a user marker 1202, and participant markers 1204 and 1206. The user marker 1202 and the participant markers 1204 and 1206 may be or comprise an avatar (e.g., 1204), an icon (e.g., 1202), the initials of the user or participant (e.g., 1206) or other identifier. The ETA of the user and each participant or attendee may be displayed in a field at the bottom of the screen 1200-B, or alternatively, next to the user or attendee marker. Activating the toggle button 1200 stops the broadcasting of the location of the user or participant to the others and navigates to another screen (e.g., the map screen 1200-A in FIG. 12A, meeting list screen 500 in FIG. 5, etc.).

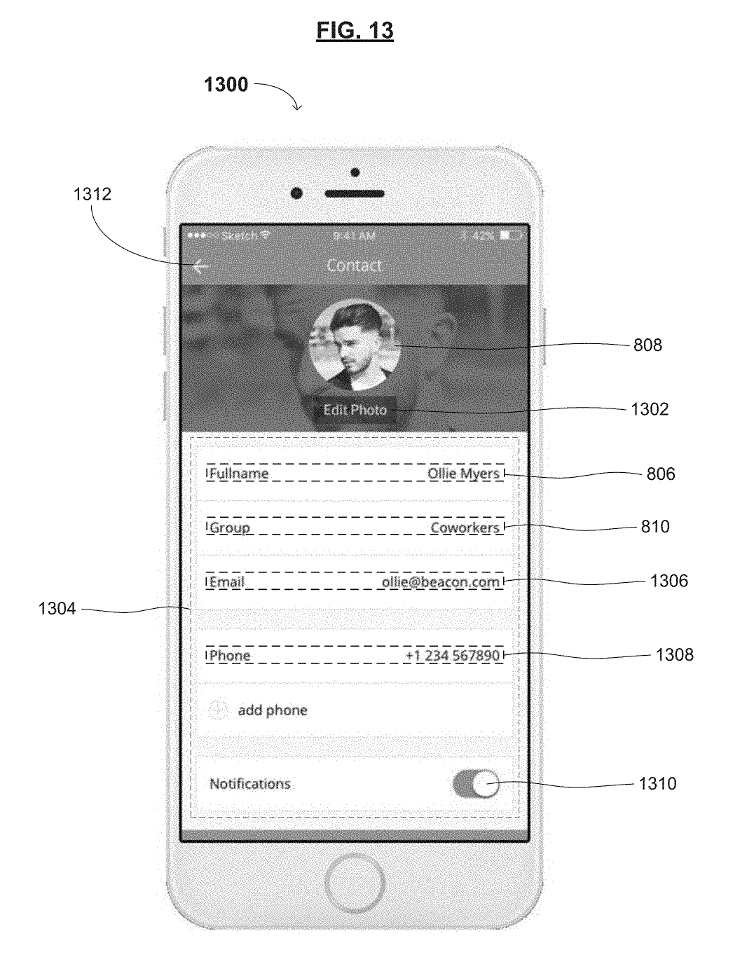

FIG. 13 shows an exemplary participant editing screen 1300 comprising a return button 1312, the participant avatar 808, a button 1302 to edit the participant avatar 808, and an editing field 1304. The editing field 1304 includes buttons or bars for editing the participant name 806, the participant category 810, a participant email 1306, and a participant phone number 1308. The field 1304 also includes a notification button 1310. The return button 1312 navigates to a previous screen (e.g., the current meeting screen 900 in FIG. 9). The notification button 1310 allows the user to receive notifications from the participant and/or the participant to receive notifications from the user.

FIG. 14 shows an exemplary settings screen 1400 comprising a return button 1410, a toggle button 1406, a toggle button 1402, a toggle button 1404, and a save button 1420. The toggle button 1406 allows the user to receive push notifications (e.g., a notification that pops up even when the mobile device is in power-saving or sleep mode). The toggle button 1402 allows the user to receive text messages through the application. The toggle button 1404 allows the user to send and/or receive alerts (e.g., one or more reminders of the meeting information [e.g., starting time, a predetermined amount of time before the starting time). The return button 1410 navigates to a previous screen (e.g., the menu screen 400 in FIG. 4). The save button 1420 applies any changes made on the settings screen 1400 and saves them on the memory of the user's mobile device or the server.

The application 226-A . . . 226-N of FIG. 2 may also be implemented and displayed on a web browser (e.g., the Google Chrome™ browser) as opposed to a standalone smartphone application (e.g., an application downloaded from the Apple® App Store®). The mobile devices 220-A through 220-N may be cell phones, smartphones, mobile phones, cellular phones, laptops, netbooks, tablets, electronic pads, or any other mobile electronic device with a wireless or GPS receiver.

### CONCLUSION/SUMMARY

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A computer-implemented method for organizing a meeting, comprising:
identifying a meeting location and selecting a starting time on a graphical user interface (GUI) of a mobile device of a user;
selecting or entering one or more participants for the meeting using the GUI on the mobile device of the user;
transmitting one or more invitations to at least one mobile device of each of the one or more participants using the GUI on the mobile device of the user and a server to which the mobile device of the user is operably linked;
receiving at least one acceptance from at least one of the one or more participants using the mobile device of the user and the server;
using a global positioning system (GPS) and the server, determining a distance between the meeting location and (i) the at least one mobile device of the at least one of the one or more participants and (ii) the mobile device of the user;
calculating a first estimated time of arrival (ETA) from each of the at least one of the one or more participants and the user to the meeting location using the GPS, the server and the mobile devices; and
displaying on the mobile devices of each of the user and the at least one of the one or more participants the first ETA(s) of the other(s) of the user and the at least one of the one or more participants.

2. The method of claim 1, further comprising displaying an electronic map showing the meeting location on the GUI of the mobile devices of each of the user and the at least one of the one or more participants.

3. The method of claim 1, further comprising, using the server and the GUIs on the mobile devices of each of the user and the at least one of the one or more participants, prompting the user and the at least one of the one or more participants to transmit to the mobile device of the other(s) of the user and the at least one of the one or more participants the location of the mobile device of the prompted user or the prompted participant.

4. The method of claim 3, further comprising displaying an electronic map showing the meeting location on the GUI of the mobile devices of each of the user and the at least one of the one or more participants.

5. The method of claim 4, wherein the electronic map further shows the location(s) of the prompted user and the prompted participant(s) choosing to display their location.

6. The method of claim 1, further comprising, in response to a selection, stimulus or input from the user, displaying a list of the one or more participants on the GUI of the mobile device of the user, wherein each participant in the list of the one or more participants includes (1) a participant name and (2) a participant email address or a participant phone number.

7. The method of claim 1, further comprising calculating a second ETA from each of the at least one of the one or more participants and the user to the other(s) of the at least one of the one or more participants and the user using the GPS, the server and the mobile devices, and displaying on the mobile devices of each of the user and the at least one of the one or more participants the second ETA(s) of the other(s) of the user and the at least one of the one or more participants.

8. A system for organizing a meeting, the system comprising:
a mobile device of a user, having a graphical user interface (GUI) configured to enable the user to designate a location and a starting time of the meeting;
one or more mobile devices of one or more participants, each having a GUI configured to enable the one or more participants to accept an invitation to the meeting;
a global positioning system (GPS) operably linked to the mobile devices of the user and the one or more mobile devices of the one or more participants, the GPS being configured to track locations of the mobile devices of the user and the one or more participants; and
a server operably linked to the GPS and the mobile devices of the user and the one or more participants, the server being configured to (i) receive (1) the location and the starting time of the meeting from the mobile device of the user, (2) an acceptance of the invitation from at least one of the one or more mobile devices of the one or more participants, and (3) the locations of the mobile devices of the user and the at least one of the one or more participants from the GPS, (ii) calculate a first estimated time of arrival (ETA) from the user and the at least one of the one or more participants to the location of the meeting, and (iii) transmit the first ETA of each of the user and the at least one of the one or more participants to the mobile devices of the other(s) of the user and the at least one of the one or more participants.

9. The system of claim 8, wherein the mobile device of the user and the GUI are configured to display an electronic map that shows a location of the meeting.

10. The system of claim 8, wherein the mobile device of the user is configured to display an interface enabling the user to transmit to the mobile devices of the at least one of the one or more participants the first ETA of the user, and optionally, the location of the mobile device of the user.

11. The system of claim 8, wherein the mobile device(s) of each of the at least one of the one or more participants is/are configured to display an interface enabling each of the at least one of the one or more participants to transmit to the mobile devices of the other(s) of the user and the at least one of the one or more participants the first ETA of a respective or corresponding one of the at least one of the one or more participants, and optionally, the location of the respective one of the at least one of the one or more participants.

12. The system of claim 11, wherein the mobile devices of the user and the at least one of the one or more participants are configured to display an electronic map that shows the meeting location and the location(s) of the other(s) of the user and the at least one of the one or more participants who transmit their location to the mobile devices of the other(s) of the user and the at least one of the one or more participants.

13. The system of claim 8, wherein the server is configured to calculate a second ETA from the user and the at least one of the one or more participants to the other(s) of the user and the at least one of the one or more participants, and transmit the second ETA of each of the user and the at least one of the one or more participants to the mobile devices of the other(s) of the user and the at least one of the one or more participants.

14. A tangible computer-readable storage medium storing a set of instructions, which when executed by a processor on a mobile device of a user cause the processor and/or the mobile device to at least:
enable the user to identify a location and a starting time of a meeting;
enable the user to select one or more participants to the meeting;
enable the user to transmit one or more invitations to the one or more participants;
enable the user to receive an acceptance from each of the one or more participants; and
display on a graphical user interface (GUI) of the mobile device of the user a first estimated time of arrival (ETA) to the location from each of (i) the user and (ii) each of the one or more participants from whom the acceptance is received.

15. The tangible computer-readable storage medium of claim 14, wherein the set of instructions include at least one instruction to display an electronic map on the GUI of the mobile device of the user to show the meeting location.

16. The tangible computer-readable storage medium of claim 15, wherein the set of instructions include at least one instruction to display on the GUI of the mobile device of the user a location of each of the one or more participants from whom (i) the acceptance and (ii) an authorization to display the location of the participant are received.

17. The tangible computer-readable storage medium of claim 16, wherein the set of instructions include at least one instruction to enable the user to transmit the location of the mobile device of the user to each of the one or more participants from whom the acceptance is received.

18. The tangible computer-readable storage medium of claim 14, wherein the set of instructions include at least one instruction to display on the GUI of the mobile device of the user a second ETA of (i) the user to each of the one or more participants and (ii) the one or more participants from whom the acceptance is received to the other(s) of the one or more participants from whom the acceptance is received.

19. A tangible computer-readable storage medium storing a set of instructions, which when executed by a processor on a server cause the processor and/or the server to:
receive and store a location and a starting time for a meeting from a mobile device of a user;
transmit one or more invitations to at least one mobile device of one or more participants received from the mobile device of the user;
receive at least one acceptance from at least one mobile device of the one or more participants;
using a global positioning system (GPS) and the server, determine a distance between the meeting location and each of the mobile devices of (i) the user and (ii) each of the one or more participants from whom the acceptance is received;
using the server, calculate a first estimated time of arrival (ETA) to the meeting location from each of (i) the user and (ii) each of the one or more participants from whom the acceptance is received; and
using the server, transmit to the mobile devices of each of (i) the user and (ii) each of the one or more participants from whom the acceptance is received the first ETAs of the other(s) of the user and the one or more participants from whom the acceptance is received.

20. The tangible computer-readable storage medium of claim 19, wherein the set of instructions include at least one instruction to: (i) prompt the one or more participants from whom the acceptance is received to transmit to the mobile device of the other(s) of the user and the one or more participants from whom the acceptance is received the location of the mobile device of the prompted participant; (ii) display on the GUI of the mobile device of the user a location of each of the one or more participants from whom (1) the acceptance and (2) an authorization to display the location of the participant are received; (iii) when authorized by the user, transmit the location of the mobile device of the user to each of the one or more participants from whom the acceptance is received; (iv) transmit a predetermined time before the meeting a reminder to the user and the one or more participants from whom the acceptance is received; (v) and/or calculate a second ETA of each of the user and the one or more participants from whom the acceptance is received to the other(s) of (a) the user and (b) each of the one or more participants from whom the acceptance is received and to transmit to the mobile devices of each of (c) the user and (d) the one or more participants from whom the acceptance is received the second ETAs of the other(s) of the user and the one or more participants from whom the acceptance is received.
